(19) United States
(12) Patent Application Publication
(10) Pub. No.: US 2012/0026226 A1
(43) Pub. Date: Feb. 2, 2012

(54) INKJET HEAD AND METHOD OF MANUFACTURING THE SAME

(75) Inventor: Takashi KIKUCHI, Shizuoka-ken (JP)

(73) Assignee: TOSHIBA TEC KABUSHIKI KAISHA, Tokyo (JP)

(21) Appl. No.: 13/188,143

(22) Filed: Jul. 21, 2011

(30) Foreign Application Priority Data
Jul. 28, 2010 (JP) 2010-169692

(51) Int. Cl. B41J 2/01; B23P 17/04

(52) U.S. Cl. 347/9; 29/890.1

(57) ABSTRACT

According to one embodiment, an inkjet head includes a head main body having a plurality of nozzles and drive elements which discharges ink from the plurality of nozzles, a control section which controls the drive elements, and a ceramic base on which the head main body and the control section are arranged. The inkjet head further includes a cover which is formed of a resin in which ceramic particles are mixed, and fixed to the base to cover the control section and hold the control section inside, and an adhesive which is interposed between the base and the cover, and seals an interior of the cover.

### CROSS-REFERENCE TO RELATED APPLICATIONS

This application is based upon and claims the benefit of priority from Japanese Patent Application No. 2010-169692, filed on Jul. 28, 2010, the entire contents of which are incorporated herein by reference.

### FIELD

Embodiments described herein relate generally to an inkjet head including a cover which covers a control section.

### BACKGROUND

Inkjet printers use various types of inkjet heads, such as an ink circulating inkjet head which circulates ink between the inside of a head and the outside of the head, and a non-circulating inkjet head which uses up all of the ink supplied in the head.

Generally, an inkjet head includes a plurality of nozzles formed on a nozzle plate, a drive element which is provided in an ink chamber and discharges ink from the nozzles, and a drive circuit which is provided outside the ink chamber and on which an electronic component, such as a driver IC, for driving the drive element is mounted. In addition, in many cases, the inkjet head is used in a state where it is fixed to a ceramic base, for example.

One idea to protect the drive circuit on which the above-mentioned electronic component is mounted from ink is to arrange a cover made of a synthetic resin which is capable of covering the drive circuit, and bond the cover to a base by an adhesive. However, the ceramic base and the cover made of a synthetic resin have different coefficients of linear expansion. For this reason, when the temperature of the inkjet head becomes high during discharge of the ink, cracks may occur in the adhesive. Thus, the ink may leak inside from the cracked parts and cause a malfunction.

### BRIEF DESCRIPTION OF THE DRAWINGS

FIG. 1 is a perspective view which shows an inkjet head of the present embodiment;

FIG. 2 is a top view which shows the inkjet head shown in FIG. 1;

FIG. 3 is an exploded perspective view which schematically illustrates a head main body of the inkjet head shown in FIG. 1; and

FIG. 4 is a graph which shows test results of an immersion test of an adhesive of the present embodiment.

### DETAILED DESCRIPTION

In general, according to one embodiment, an inkjet head includes a head main body having a plurality of nozzles and drive elements which discharges ink from the plurality of nozzles, a control section which controls the drive elements, and a ceramic base on which the head main body and the control section are arranged. The inkjet head further includes a cover which is formed of a resin in which ceramic particles are mixed, and fixed to the base to cover the control section and hold the control section inside, and an adhesive which is interposed between the base and the cover, and seals an interior of the cover.

A first embodiment of an inkjet head will now be described with reference to drawings. The inkjet head is mounted in a printing device, such as a printer, and while receiving supply of ink from an ink tank, ink droplets are discharged toward a to-be-printed object, thereby forming a character and image on the to-be-printed object. Further, in the present embodiment, an explanation will be given for a case where the present invention is applied to a non-circulating inkjet head in which ink is not circulated between the inside of a head and the outside of the head, as an example. However, needless to say, the present invention can also be applied to an ink circulating inkjet head.

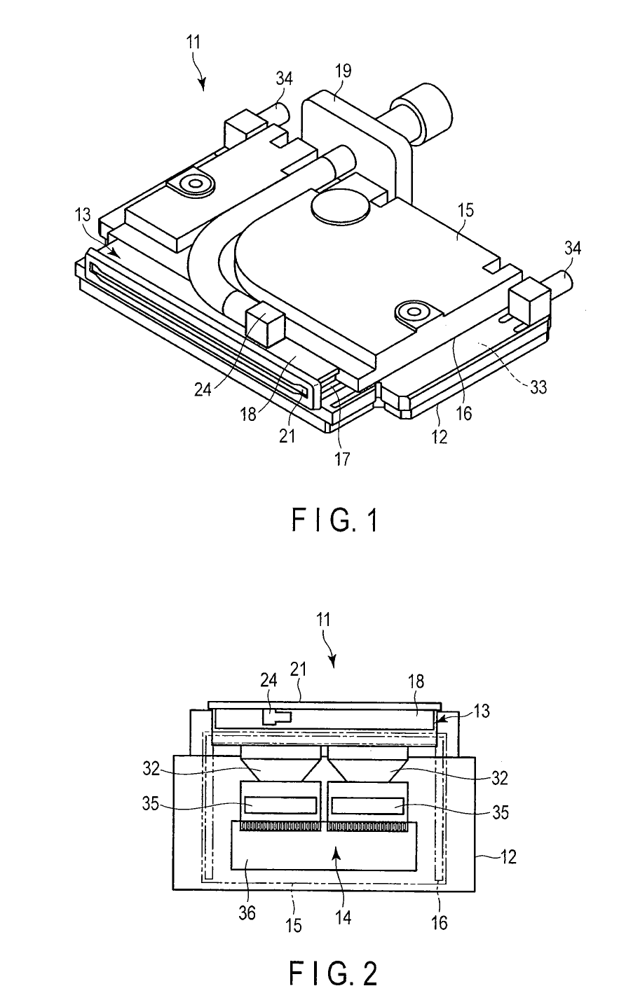

As shown in FIGS. 1 and 2, an inkjet head 11 comprises a base 12 which is flat-shaped, a head main body 13 and a control section 14 which are arranged on the base 12, a cover 15 which is fixed on the base 12 to cover the control section 14, and an adhesive 16 which is interposed between the base 12 and the cover 15. The inkjet head 11 further comprises a filter 19 for removing dust from the ink which is located near the connection to an ink tank which is not shown.

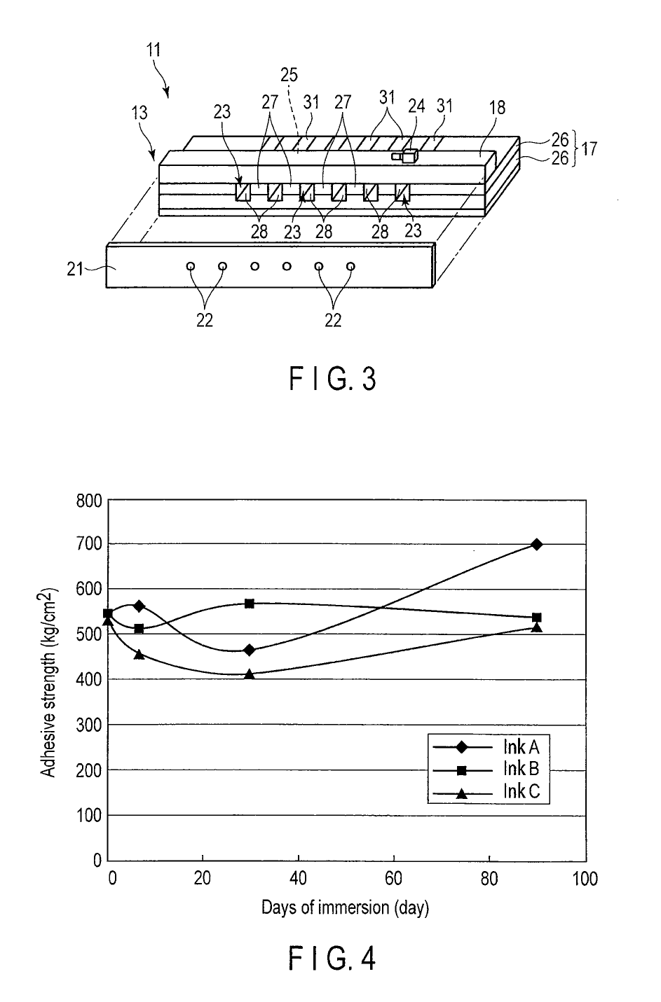

As shown in FIG. 3, the head main body 13 comprises, for example, a substrate 17, a top panel 18 which is bonded to the substrate, and a nozzle plate 21 which is bonded to the substrate 17 and the top panel 18 in such a manner that extends therebetween. The nozzle plate 21 includes a plurality of nozzles 22. In a state where the nozzle plate 21 is bonded to the substrate 17 and the top panel 18, the nozzles 22 communicate with pressure chambers 23, respectively.

On the top panel 18, a supply port 24 for supplying ink inside the head main body 13 is provided. Further, a common fluid chamber 25 is provided inside the top panel 18, and the common fluid chamber 25 communicates with each of the pressure chambers 23.

The substrate 17 is formed by bonding together two piezolelectric members 26 which are made of lead zirconate titanate (PZT) such that their polarization directions are opposed to each other. The substrate 17 comprises a plurality of pressure chambers 23 which are formed like grooves on one surface of the substrate, struts 27 which are an example of a drive element provided on both sides of the pressure chambers 23, and electrodes 28 which are formed on a side surface of each of the struts 27 and the bottom of the pressure chambers 23. Further, on the substrate 17, a plurality of wiring lines 31 are provided. The wiring lines 31 are connected to the electrodes 28 at one end and connected to a flexible printed wiring board 32 of the control section 14 at the other end.

The base 12 is formed of a ceramic material, such as alumina, for example. The coefficient of linear expansion of the base 12 made of alumina is 5×10⁻⁶ to 7×10⁻⁶, for example. The base 12 includes a temperature adjustment channel 33 which is made inside the base 12, and an adapter 34 which is connected to the channel 33. A fluid can be flowed inside the temperature adjustment channel 33. By making hot water which is controlled to have a constant temperature flow inside the temperature adjustment channel 33, the temperature of the head main body 13 and a driver IC 35 of the control section 14 can be maintained at a constant level.

The control section 14 can directly control the struts 27 of the substrate 17 to discharge ink from the nozzles 22. The control section 14 comprises the flexible printed circuit board 32 which is connected to the wiring lines 31, the driver IC 35 which is electrically connected to the flexible printed circuit board 32, and a drive circuit 36 which is electrically connected to the driver IC 35.

To perform printing processing with a printing device, which is equipped with the head main body 13 and the control section 14 of the inkjet head 11 mentioned above, it is necessary to supply ink to the head main body 13 from the ink tank of the printing device. The supply of the ink is performed via the supply port 24, and the ink which has flowed out of the ink tank is supplied within each of the pressure chambers 23 through the supply port 24 and the common fluid chamber 25.

In this state, if a user instructs printing to a printer, a main substrate of the printer outputs a signal for printing instruction with respect to the control section 14 of the ink jet head 11. The driver IC 35 of the control section 14 which received the signal for printing instruction applies a pulse voltage to the struts 27 via the wiring lines 31. By the application of the pulse voltage, a pair of struts 27 (right and left struts 27) is drawn apart in a bending manner as a result of shear mode deformation. Further, by restoring these struts to an initial position and raising a pressure within the pressure chambers 23, ink droplets are discharged from the nozzles 22 with great force.

The cover 15 is formed to have a configuration of a recessed portion for accommodating the control section 14 inside. The cover 15 is formed of a resin material which is made by mixing a ceramic filler into a synthetic resin, such as poly phenylene sulfide resin (PPS) and polybutyleneterephthalate resin (PBT). The ceramic particles comprise inorganic particles, such as SiO₂. More specifically, the cover 15 is formed by molding a mixture comprising either PPS or PBT and further comprising 30 to 40% by weight of an inorganic substance, such as SiO₂.

The coefficient of linear expansion of the cover 15 is 1×10⁻⁵ to 2×10⁻⁵. Since the coefficient of linear expansion of PPS without the filler is 7×10⁻⁵ to 10×10⁻⁵, the coefficient of linear expansion of the cover 15 of the present embodiment is approximately 5 to 10 times smaller than that of PPS without the filler.

Accordingly, in the present embodiment, the coefficient of linear expansion of the cover 15 is equal to that of the base 12 or greater than that of the base 12 by not more than 10 times.

As shown in FIG. 2, the adhesive 16 is applied to the base 12 and the head main body 13 in the form of “C” substantially. The adhesive 16 is interposed between the base 12 and the cover 15, and can seal the interior of the cover 15. Further, the adhesive 16 covers both a gap between the cover 15 and the base 12 and a gap between the cover 15 and the head main body 13.

A base compound of the adhesive 16 is formed of a bisphenol A-type epoxy resin or a bisphenol F-type epoxy resin, or a combination of the two. Further, as a curing agent, the adhesive 16 contains a curing agent made of epoxy resin (epoxy resin curing agent), for example. The coefficient of elasticity of the adhesive 16 is within the range of 3 to 3.5 GPa. Since the adhesive 16 of the present embodiment contain the curing agent made of epoxy resin, an ink resistance property is imparted to the adhesive 16.

When the heat cycle test, which varies the temperature within the range of −10 to 60° C., is performed on the inkjet heat 11 structured as stated above, even if such thermal hysteresis is applied to the inkjet head 11, no cracks occurred in the adhesive 16.

As shown in FIG. 4, the inventors carried out an immersion test, which immerses the adhesive 16 to be used in the present embodiment in ink to judge whether the adhesive 16 is resistant to ink. In the immersion test, the adhesive 16 was immersed in ink A, ink B, and ink C for a predetermined number of days (one week, one month, and three months), under the condition of 45° C., to evaluate the ink resistance property of the adhesive 16. For all of ink A, ink B, and ink C, acrylic UV curable ink was used. When this test was conducted, in all cases, adhesive strength of the adhesive did not fall below 100 kg/cm², which is a reference value, and it has been confirmed that the adhesive 16 has a resistance property to all of ink A, ink B, and ink C.

According to the first embodiment, the inkjet head 11 comprises the head main body 13 including the nozzles 22 and the drive element which discharges ink from the nozzles 22, the control section 14 which controls the drive element, the ceramic base 12 on which the head main body 13 and the control section 14 are mounted, the cover 15 which is formed of a resin in which ceramic particles are mixed, and fixed to the base 12 to cover the control section 14 and hold it inside, and the adhesive 16 which is interposed between the base 12 and the cover 15, and seals the interior of the cover 15.

Since the ceramic particles are mixed into the resin for forming the cover 15, the structure as stated above enables to reduce a difference between the coefficient of linear expansion of the cover 15 and that of the base 12. By this structure, it is possible to prevent cracks from occurring in the adhesive 16, and prevent ink from leaking inside the cover 15 and affecting the control section 14. Thus, a highly-reliable inkjet head 11 can be provided.

The adhesive 16 is made by adding the curing agent made of epoxy resin to the epoxy resin comprising at least one of a bisphenol A-type epoxy resin and a bisphenol F-type epoxy resin. By adopting this structure, an ink resistance property can be imparted to the adhesive 16, thereby preventing the swelling of the adhesive 16 and reduction in the adhesive strength of the adhesive 16.

The coefficient of linear expansion of the cover 15 is equal to that of the base 12 or greater than that of the base 12 by not more than 10 times, and the coefficient of elasticity of the adhesive 16 is 3 to 3.5 GPa. If an adhesive has a coefficient of elasticity of 3 GPa or less, gaps are formed between molecules, which causes a problem of damage by partial ink. On the other hand, if the coefficient of elasticity is 3.5 GPa or more, elasticity is not sufficient, and cracks may occur in the adhesive 16 when thermal hysteresis is applied to the inkjet head 11. With the above-mentioned structure, it is possible to make the adhesive 16 have such elasticity as to allow the adhesive 16 follow the thermal expansion of the cover 15, and also make the adhesive 16 have a property of not being affected by ink.

The inkjet head 11 is not limited to the above embodiment, and may be embodied by modifying constituent features without departing from the spirit when the inkjet head is put into practice. Further, various inventions can be achieved by suitably combining the constituent features disclosed in the above embodiment. For example, some constituent features may be deleted from the entire constituent features shown in the embodiment. Further, constituent features of different embodiments may be combined suitably.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet head comprising:
a head main body including a plurality of nozzles and a plurality of drive elements configured to discharge ink from the plurality of nozzles;
a control section configured to control the drive elements;
a ceramic base on which the head main body and the control section are arranged;
a cover which is formed of a resin in which ceramic particles are mixed, and fixed to the base to cover the control section and hold the control section inside; and
an adhesive which is interposed between the base and the cover, and seals an interior of the cover.

2. The inkjet head according to claim 1, wherein the adhesive comprises an epoxy resin comprising at least one of a bisphenol A-type epoxy resin and a bisphenol F-type epoxy resin, and further comprises a curing agent made of epoxy resin as an additive.

3. The inkjet head according to claim 2, wherein
the cover has a coefficient of linear expansion which is equal to the coefficient of linear expansion of the base or greater than that of the base by not more than 10 times, and
the adhesive has a coefficient of elasticity ranging from 3 to 3.5 GPa.

4. The inkjet head according to claim 3, wherein the base includes a channel which is made inside the base, and allows a temperature controlled fluid to flow through.

5. The inkjet head according to claim 4, wherein the cover is formed by mixing SiO₂ particles to one of poly phenylene sulfide resin and polybutyleneterephthalate resin.

6. The inkjet head according to claim 5, wherein the head main body comprises:
a substrate which is formed by bonding together two piezolelectric members such that their polarization directions are opposed to each other;
a plurality of pressure chambers which are formed like grooves on one surface of the substrate;
the drive elements which are provided on respective sides of the pressure members; and
a plurality of wiring lines which is configured to apply a voltage to the drive elements.

7. The inkjet head according to claim 6, wherein the head main body includes:
a supply port which is configured to supply ink inside the head main body; and
a common fluid chamber which is provided within the head main body and communicates with each of the pressure chambers.

8. The inkjet head according to claim 7, wherein the control section includes:
a flexible printed circuit board which is connected to the wiring lines;
a driver IC which is electrically connected to the flexible printed circuit board; and
a drive circuit which is electrically connected to the driver IC.

9. The inkjet head according to claim 8, further comprising a filter for removing dust from the ink.

10. A method of manufacturing an inkjet head comprising:
a head main body including a plurality of nozzles and a plurality of drive elements configured to discharge ink from the plurality of nozzles;
a control section configured to control the drive elements;
a ceramic base on which the head main body and the control section are arranged;
a cover which is formed of a resin in which ceramic particles are mixed, and fixed to the base to cover the control section and hold the control section inside; and
an adhesive which is interposed between the base and the cover, and seals an interior of the cover, the method comprising:
applying the adhesive on the base; and
fixing the cover to the base by interposing the adhesive between the base and the cover to seal the interior of the cover.

11. The method according to claim 10, wherein the adhesive comprises an epoxy resin comprising at least one of a bisphenol A-type epoxy resin and a bisphenol F-type epoxy resin, and further comprises a curing agent made of epoxy resin as an additive.

12. The method according to claim 11, wherein
the cover has a coefficient of linear expansion which is equal to the coefficient of linear expansion of the base or greater than that of the base by not more than 10 times, and
the adhesive has a coefficient of elasticity ranging from 3 to 3.5 GPa.
